(19) United States
(12) Patent Application Publication
(10) Pub. No.: US 2020/0387485 A1
(43) Pub. Date: Dec. 10, 2020

(54) CUSTOMIZING PRODUCT DOCUMENTATION WITHOUT DUPLICATING DOCUMENTATION

(71) Applicant: Microsoft Technology Licensing, LLC, Redmond, WA (US)

(72) Inventors: Peter Eric LOFORTE, Issaquah, WA (US); Katharine Elizabeth GRANT, Seattle, WA (US); Paul Fraedrich ESTES, Bellevue, WA (US); Adam Dewayne MILLER, North Bend, WA (US); Kapil Kumar TUNDWAL, Kirkland, WA (US); David Lawrence SWIFT, Seattle, WA (US); Gabriele MASILI, Mercer Island, WA (US); Raymond Robert RINGHISER, Maple Valley, WA (US)

(21) Appl. No.: 16/436,264

(22) Filed: Jun. 10, 2019

(51) Int. Cl. G06F 16/21; G06F 16/23

(52) U.S. Cl. CPC G06F 16/219; G06F 16/2358

(57) ABSTRACT

A system for customizing product documentation. In one example, the system includes an electronic computing device including an electronic processor. The electronic processor is configured to receive, from a user device, log-on credentials, determine, based on the log-on credentials, an organization, and receive, from a database server, product documentation for a product. The electronic processor is also configured to receive, from the database server, modifications for the product documentation that are associated with the organization, apply the modifications to the product documentation to create modified product documentation, and send, to the user device, the modified product documentation.

### FIELD

Embodiments described herein relate to providing customized documentation to users based on an organization the user belongs to.

### SUMMARY

When a company develops a product such as a software product, the company typically distributes the product to multiple organizations and creates documentation associated with the product. An organization may be, for example, a company, an educational institution, a government agency, or the like. Individuals belonging to organizations that use the product may access the product documentation for information regarding the product. It is common that each organization has specific policies relating to product usage that do not conform to or are not included in the product documentation. In one example, product documentation may include information regarding features of the product that are disabled by an administrator of an organization. In another example, the organization may want their members to use a feature of the product in a specific way (for example, always use this watermark for this type of document). In yet another example, the organization may want their members to contact a specific support group for help with using the product. For example, uncustomized product documentation may state “Contact ACME, Inc. Support at 1-800 . . . ” but the organization incurs a cost each time a member calls the number.

Therefore, an organization may create customized product documentation that reflects the organization's configuration of the product, preferred use of the product, and preferred support contacts for the product. For example, an organization may customize the product documentation to include its own, internal support team's contact information or, for each aspect of the product, contact information for an individual or team within the organization supporting that aspect of the product (for example, “For issues or questions about purchasing, please contact Fred at 12345. For issues or questions with installation or use of this tool, please contact Donna at 23456.”). Currently, the ability of organizations to customize product documentation is limited and often requires duplicating the product documentation. Duplicating product documentation at a server wastes computer memory and also leads to problems in maintaining up-to-date product documentation. Therefore, there is a need for a system that allows for customizing product documentation without needing to duplicate the product documentation.

Embodiments described herein provide a system and method for customizing product documentation. Rather than duplicating product documentation for each organization whose members modify the product documentation, certain embodiments described herein store modifications made by members of an organization to product documentation. When a user logs into a web application to view product documentation, the organization that the user belongs to (is a member of) is determined based on the user's log-on credentials. The product documentation as created by the company distributing the product is retrieved from the database in which it is stored. Based on the organization that the user is a member of, modifications made to the product documentation by members of the same organization are also retrieved from the database. The retrieved modifications are applied to the retrieved product documentation to create modified product documentation. The modified product documentation is displayed. In some embodiments described herein, user metrics associated with the modified product documentation are also displayed.

One embodiment provides a system for customizing product documentation. The system includes an electronic computing device including an electronic processor. The electronic processor is configured to receive, from a user device, log-on credentials, determine, based on the log-on credentials, an organization, and receive, from a database server, product documentation for a product. The electronic processor is also configured to receive, from the database server, modifications for the product documentation that are associated with the organization, apply the modifications to the product documentation to create modified product documentation, and send, to the user device, the modified product documentation.

Another embodiment provides a method of customizing product documentation. The method includes receiving, from a user device, log-on credentials, determining, based on the log-on credentials, an organization, and receiving, from a database server, product documentation for a product. The method also includes receiving, from the database server, modifications for the product documentation that are associated with the organization, applying the modifications to the product documentation to create modified product documentation, and sending, to the user device, the modified product documentation.

Yet another embodiment provides a non-transitory computer readable medium storing instructions that, when executed with an electronic processor, perform a set of functions. The set of functions includes receiving, from a user device, log-on credentials, determining, based on the log-on credentials, an organization, and receiving, from a database server, product documentation for a product. The set of functions also includes receiving, from the database server, modifications for the product documentation that are associated with the organization, applying the modifications to the product documentation to create modified product documentation, and sending, to the user device, the modified product documentation.

These and other features, aspects, and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 schematically illustrates a system for customizing product documentation according to one embodiment.

FIG. 2 schematically illustrates a database server of the system of FIG. 1 according to one embodiment.

FIG. 3 schematically illustrates a server of the system of FIG. 1 according to one embodiment.

FIG. 4 is a flow chart illustrating a method of customizing product documentation using the system of FIG. 1 according to one embodiment.

FIG. 5 illustrates an example of a user interface including modified product documentation.

FIG. 6 illustrates an example of a user interface including metrics for product documentation and options for modifying product documentation

### DETAILED DESCRIPTION

One or more embodiments are described and illustrated in the following description and accompanying drawings. These embodiments are not limited to the specific details provided herein and may be modified in various ways. Furthermore, other embodiments may exist that are not described herein. Also, the functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way, but may also be configured in ways that are not listed. Furthermore, some embodiments described herein may include one or more electronic processors configured to perform the described functionality by executing instructions stored in non-transitory, computer-readable medium. Similarly, embodiments described herein may be implemented as non-transitory, computer-readable medium storing instructions executable by one or more electronic processors to perform the described functionality. As used in the present application, “non-transitory computer-readable medium” comprises all computer-readable media but does not consist of a transitory, propagating signal. Accordingly, non-transitory computer-readable medium may include, for example, a hard disk, a CD-ROM, an optical storage device, a magnetic storage device, a ROM (Read Only Memory), a RAM (Random Access Memory), register memory, a processor cache, or any combination thereof.

In addition, the phraseology and terminology used herein is for the purpose of description and should not be regarded as limiting. For example, the use of “including,” “containing,” “comprising,” “having,” and variations thereof herein is meant to encompass the items listed thereafter and equivalents thereof as well as additional items. The terms “connected” and “coupled” are used broadly and encompass both direct and indirect connecting and coupling. Further, “connected” and “coupled” are not restricted to physical or mechanical connections or couplings and can include electrical connections or couplings, whether direct or indirect. In addition, electronic communications and notifications may be performed using wired connections, wireless connections, or a combination thereof and may be transmitted directly or through one or more intermediary devices over various types of networks, communication channels, and connections. Moreover, relational terms such as first and second, top and bottom, and the like may be used herein solely to distinguish one entity or action from another entity or action without necessarily requiring or implying any actual such relationship or order between such entities or actions.

As described above, the ability of organizations to customize product documentation for a product such as a software product (for example, Microsoft Outlook®, Microsoft Word®, Microsoft Sharepoint®, or the like) without duplicating the product documentation is limited. Duplicating product documentation wastes computer memory, leads to problems maintaining up-to-date product documentation, or both. Therefore, a system that allows for customizing product documentation without needing to duplicate the product documentation 1) reduces the need for memory and 2) helps improve the accuracy and reduce obsolescence of information in the product documentation.

Embodiments described herein, among other things, store modifications made by an organization to product documentation. When a user logs into a web application to view product documentation, the organization that the user is a member of is determined based on the user's log-on credentials. The product documentation as created by the company is retrieved from the database in which it is stored. In some embodiments, a specific version of the product documentation as created by the company is retrieved from the database based on the organization that the user belongs to (or is a member of). Based on the organization that the user belongs to, modifications made to the product documentation by members of the same organization are also retrieved from the database. In some embodiments, a type of user is determined based on the user's log-on credentials and modifications made to the product documentation by members of the same organization for the type of user are retrieved from the database. The retrieved modifications are applied to the retrieved product documentation to create modified product documentation and the modified product documentation is displayed. Therefore, certain embodiments described herein do not require that customized product documentation be duplicated, allowing for up-to-date product documentation to be maintained and computer memory to be used efficiently. In some embodiments, user metrics associated with the modified product documentation are also displayed, allowing members of the organization to determine, among other things, features of a product that cause the greatest difficulty for other members of the organization. For example, an administrator of an organization may determine that members of the organization need training on a product feature based on how many times a section of product documentation associated with the product feature is accessed.

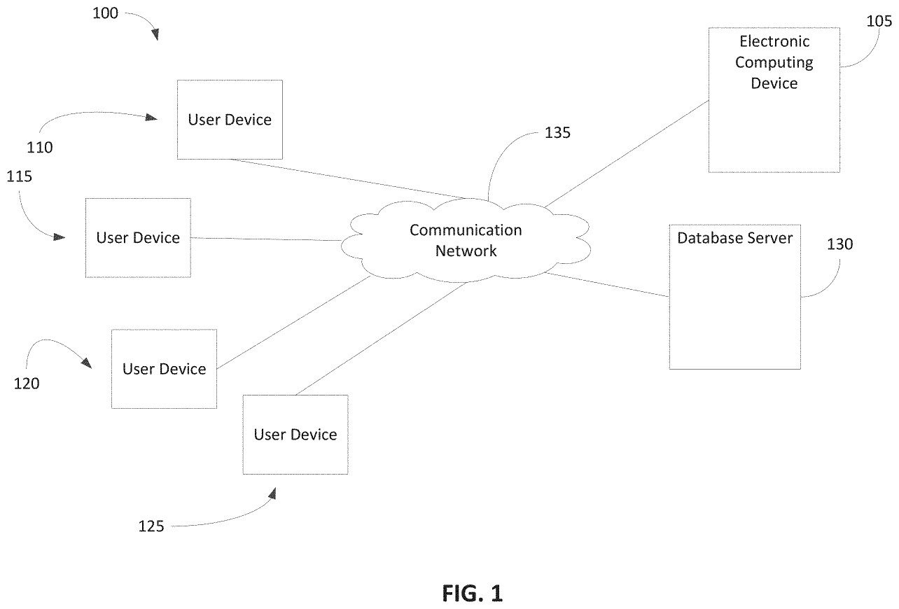

FIG. 1 schematically illustrates a system 100 for customizing product documentation. In the example illustrated, the system 100 includes an electronic computing device 105, one or more user devices 110, 115, 120, 125, and a database server 130. The electronic computing device 105, the user devices 110, 115, 120, 125, and the database server 130 communicate over one or more wired or wireless communication networks 135. Portions of the wireless communication networks 135 may be implemented using a wide area network, such as the Internet, a local area network, such as a Bluetooth™ network or Wi-Fi, and combinations or derivatives thereof. It should be understood that the electronic computing device 105 may communicate with a different number of user devices, and the four user devices 110, 115, 120, 125 illustrated in FIG. 1 are purely for illustrative purposes. Similarly, it should also be understood that the computing environment 100 may include a different number of electronic computing devices and database servers and the electronic computing device 105 and the database server 130 illustrated in FIG. 1 are purely for illustrative purposes. Also, in some embodiments, one of the user devices 110, 115, 120, 125 may communicate with the electronic computing device 105 through one or more intermediary devices (not shown). The functionality described herein as being performed by a component of the system 100 may be performed by a different component of the system 100. For example, functionality described herein as being performed by the electronic computing device 105 may instead be performed by the database server 130 or a user device.

Each user of the user devices 110, 115, 120, 125 may be associated with an organization and each of the user devices 110, 115, 120, 125 may be used by one or more members of the organization. Each user device 110, 115, 120, 125 is an electronic device, such as desktop computer, laptop computer, tablet computer, a smart phone, a smart watch, a mixed reality headset, or the like, that includes an electronic processor (for example, a microprocessor, application-specific integrated circuit (ASIC), or another suitable electronic device), a memory (for example, a non-transitory, computer-readable storage medium), and a communication interface such as a transceiver, for communicating over the communication networks 135 and, optionally, one or more additional communication networks or connections. The user devices 110, 115, 120, 125 may also include a display (for example, a touchscreen, a liquid crystal display (LCD), a light-emitting diode (LED), a LED display, an organic LED (OLED) display, an electroluminescent display (ELD), and the like) and an input device (for example, for example, a keypad, a mouse, a touchscreen (for example, as part of the display device), a microphone, a camera, or the like). The user devices 110, 115, 120, 125 communicate with the electronic computing device 105 to access the product documentation included in the database server 130.

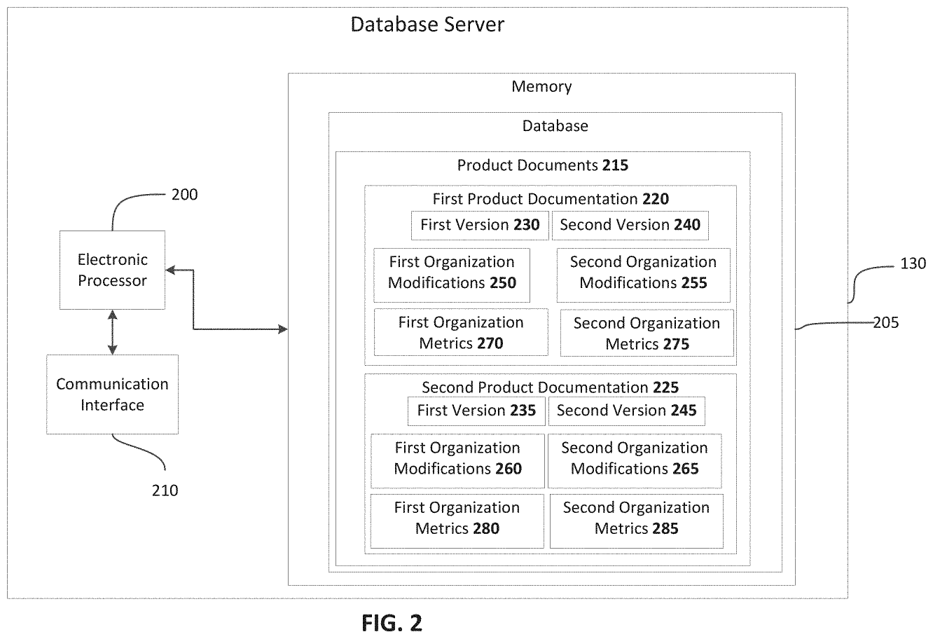

As illustrated in FIG. 2, the database server 130 is an electronic device that includes an electronic processor 200 (for example, a microprocessor, application-specific integrated circuit (ASIC), or another suitable electronic device), a memory 205 (a non-transitory, computer-readable storage medium), and a communication interface 210, such as a transceiver, for communicating over the communication networks 135 and, optionally, one or more additional communication networks or connections. The electronic processor 200, the memory 205, and the communication interface 210 communicate over one or more communication lines or buses. It should be understood that the database server 130 may include additional components than those illustrated in FIG. 2 in various configurations and may perform additional functionality than the functionality described in the present application.

In the example embodiment illustrated in FIG. 2, the memory 205 of the database 130 includes a database 212 including product documents 215. The product documents 215 are associated with at least one product distributed by a company. The product documents 215 may include documents or documentation associated with multiple products. In the example illustrated in FIG. 2, the database 212 includes first product documentation 220 and second product documentation 225. The first product documentation 220 is associated with a first product and includes one or more documents pertaining to the operation of the first product. The second product documentation 225 is associated with a second product and includes one or more documents pertaining to the operation of the second product. It should be understood that the database 212 may include product documentation for a different number of products and that the first product documentation 220 and the second product documentation 225 are provided for purely illustrative purposes. Additionally, a plurality of versions may be created for product documentation and stored in the database 212. For example, a company distributing a product may make changes to the product and release a new version of the product. When a company makes changes to a product (for example, creating a new version of the product), the company may also create a new version of product documentation including changes to the documentation corresponding to the changes to the product. However, some organizations that the product is distributed to may not upgrade to the new version of the product and, therefore, require access to a previous version of the product documentation. Other organizations will upgrade to the new version of the product and require access to the product documentation for the new version. In the example illustrated in FIG. 2, the first product documentation 220 includes a first version 230 and a second version 235 and the second product documentation 225 includes a first version 240 and a second version 245. It should be understood that a different number of versions of product documentation than the two versions illustrated herein may be stored in the database 212 for the first product documentation 220, the second product documentation 225, or both and that the first versions 230, 240 and the second versions 235, 245 are provided for purely illustrative purposes.

In some embodiments, the database 212 also includes modifications to the documentation made by members of an organization to which the product has been distributed. In the example illustrated in FIG. 2, the database 212 includes first organization modifications 250 and second organization modifications 255 for the first product documentation 220 and first organization modifications 260 and second organization modifications 265 for the second product documentation 225. In one illustrative example, when an administrator of the first organization makes a change to the first product documentation 220, such as adding a section to the product documentation, the change made by the administrator is included in the first organization modifications 250 along with other modifications that may have been made to the first product documentation 220 by the administrator (or another member of the first organization). In some embodiments, the modifications associated with an organization include a plurality of groups of modifications, each group of modifications associated with a user type.

In some embodiments, the database 212 also includes product documentation metrics associated with organizations to which the product has been distributed. Metrics included in the database 212 describe how members of an organization utilize product documentation. In the example illustrated in FIG. 2, the database 212 includes metrics describing how members of the first organization are utilizing the first product documentation 220 (first organization metrics 270) metrics describing how members of the second organization are utilizing the first product documentation 220 (second organization metrics 275), metrics describing how members of the first organization are utilizing the second product documentation 225 (first organization metrics 280), and metrics describing how members of the second organization are utilizing the second product documentation 225 (second organization metrics 285).

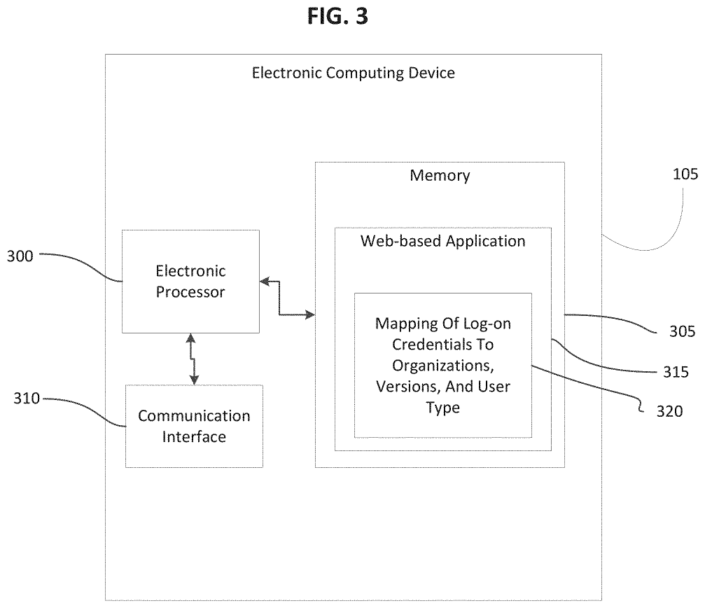

In the example illustrated in FIG. 3, the electronic computing device 105 includes an electronic processor 300 (for example, a microprocessor, application-specific integrated circuit (ASIC), or another suitable electronic device), a memory 305 (a non-transitory, computer-readable storage medium), and a communication interface 310, such as a transceiver, for communicating over the communication networks 135 and, optionally, one or more additional communication networks or connections. The electronic processor 300, the memory 305, and the communication interface 310 communicate over one or more communication lines or buses. It should be understood that the electronic computing device 105 may include additional components than those illustrated in FIG. 3 in various configurations and may perform additional functionality than the functionality described in the present application.

In some embodiments, the memory 305 of the electronic computing device 105 includes a web application 315 which provides access to product documentation when log-on credentials, such as a user name, a password, domain, organization name, securelD, a combination of the foregoing, or the like are received. The web application 315 includes a mapping 320 that maps log-on credentials to organizations, documentation versions, and user types. In some embodiments, the mapping 320 also maps log-on credentials to editing permissions. In one example, the mapping 320 may include a list of domains. Each listed domain may be mapped to an organization. Each organization may be mapped to each product documentation available to the organization and an associated version for each product documentation. The mapping 320 may also include a list of usernames, passwords, aliases, a combination thereof, or the like. Each entry in the list of usernames may be mapped to a type of user (for example, researcher, developer, sales representative, or the like) and editing permissions.

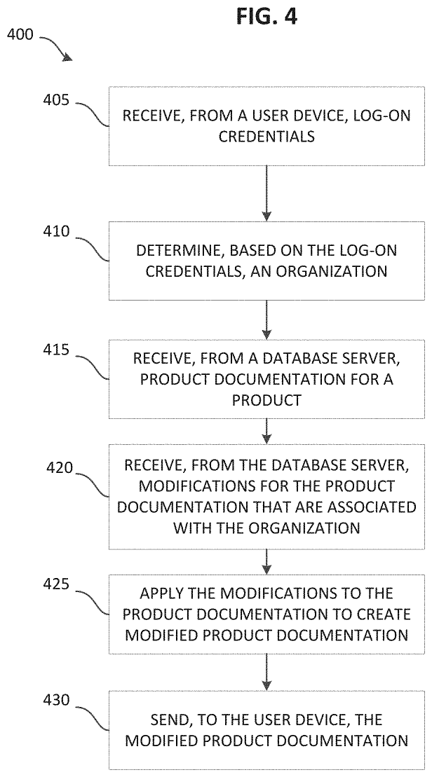

FIG. 4 is a flowchart of an example method 400 of customizing product documentation. The method 400 is executed when a user device, for example, one of the user devices 110, 115, 120, 125 access a web-based application 315 (for example, C3 as provided by C3IT Solutions) executed by the electronic processor 300. At step 405, the electronic processor 300 of the electronic computing device 105 receives, from one of the user devices 110, 115, 120, 125 via the communications network 135, log-on credentials. The received log-on credentials are associated with, for example, a member of an organization with access to product documentation provided by a company. In one example, the electronic processor 300 may receive, as log-on credentials, a username (for example, john.smith@companyX.com) and a password (for example, 123&xyz). At step 410, the electronic processor 300 determines, based on the log-on credentials, an organization. In some embodiments, the electronic processor 300 determines the organization associated with log-on credentials by using a domain included in the log-on credentials. For example, if the log-on credentials include the username john.smith@companyX.com, the electronic processor 300 extracts, from the username, the domain. In this example, the domain is defined as characters in the username that come after the ‘@’ character and before the top level domain (TDL) (in this example the TDL is .com). Therefore, the electronic processor 300 determines the domain to be companyX. The electronic processor 300 uses the mapping 320 to determine the organization associated with the determined domain. The electronic processor 300 also uses the mapping 320 to determine products and product documentation, including which version of product documentation, members of the organization have access to. For example, the electronic processor 300 may use the mapping 320 to determine that the domain companyX is associated with the organization X Enterprises and that a member of X Enterprises may view the first version 230 of the first product documentation 220 and the second version 245 of the second product documentation 225. In some embodiments, in addition to determining an organization associated with log-on credentials, the electronic processor 300 also determines a user type, editing permissions, or both associated with the log-on credentials. For example, the electronic processor 300 may use the alias john.smith, the password 123&xyz, or both to determine the type of user associated with the log-on credentials is developer.

In some embodiments, the electronic processor 300 sends a list of product documentation accessible by members of the determined organization to the user device from which the log-on credentials were received. The electronic processor 300 may receive a selection of product documentation from the user device.

In some embodiments, when the electronic processor 300 receives a selection of product documentation from the user device, the electronic processor 300 sends, to the database server 130, a request for the selected product documentation. In other embodiments, the electronic processor 300 sends, to the database server 130, a request for all product documentation that members of the determined organization have access to. In some embodiments, the electronic processor 300 requests a version of the product documentation that is determined based on the organization associated with the log-on credentials. At step 415, the electronic processor 300 receives, from the database server 130, product documentation for a product. If the electronic processor 300 requested a specific version of product documentation, the electronic processor 300 receives, from the database server 130, the requested version of product documentation.

The electronic processor 300 also sends, to the database server 130, a request for modifications for each product documentation received by the electronic processor 300 at step 415. The request includes the organization determined in step 410 and, in some embodiments, the determined type of user. At step 420, the electronic processor 300 receives, from the database server 130, modifications for the product documentation that are associated with the determined organization and, in some embodiments, the determined type of user.

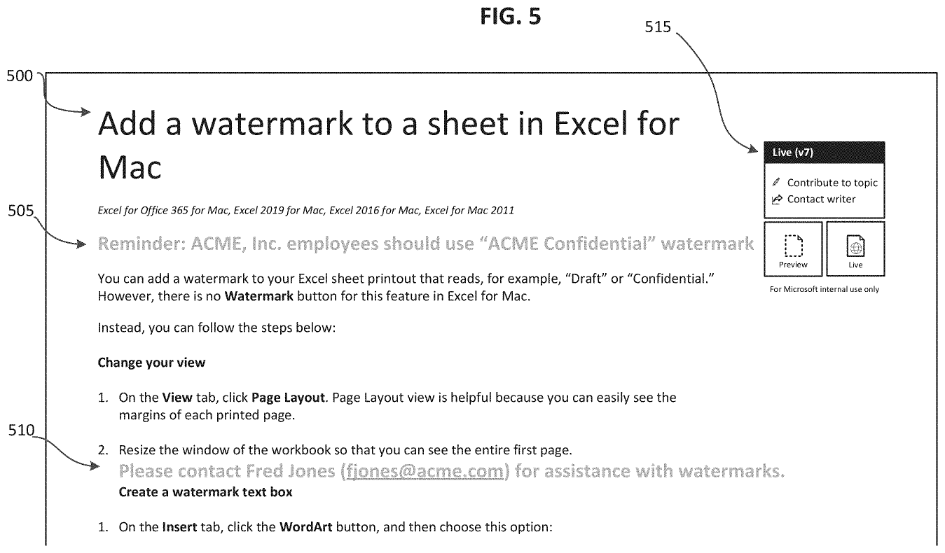

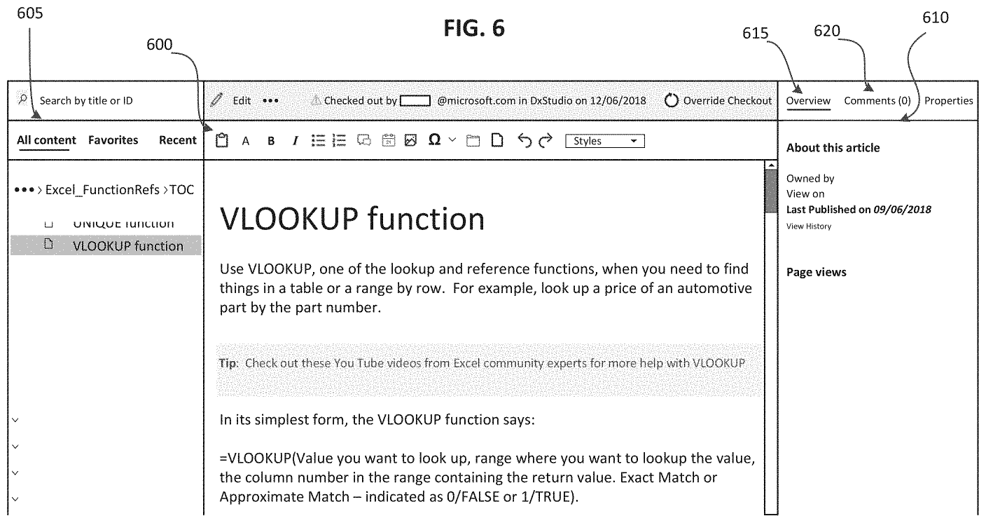

At step 425, the electronic processor 300 applies the modifications received from the database server 130 to the product documentation received from the database server 130 to create modified product documentation that is customized to members of an organization and, in some embodiments, types of users. At step 430, the electronic processor 300 sends, to the user device, the modified product documentation. The user device may display the modified product documentation via a display and, in some embodiments, display options for editing the product documentation. FIG. 5 illustrates an example of modified product documentation 500 displayed by a display of a user device. In some embodiments, modifications to the product documentation are marked. For example, modifications may be highlighted, underlined, bolded, italicized, in grayscale or color (as the modifications 505, 510 illustrated in FIG. 5 are), a combination of the foregoing, or the like. FIG. 5 also illustrates a widget 515 displayed on the display of the user device. When the user device receives a selection of the widget 515 (or a button, link, or the like within the widget) and the user device has received log-on credentials for a user with permission to edit product documentation, the user device displays options for editing the product documentation as illustrated in FIG. 6.

In some embodiments, the electronic processor 300 receives, from a user device (for example, the user device 110), a modification to product documentation. For example, an administrator who is a member of an organization and has provided log-on credentials to the electronic processor 300 via the user device 110 may modify product documentation that has been distributed to the organization the administrator belongs to. In a manner similar to that described above, the electronic processor 300 determines an organization associated with the log-on credentials received from the user device 110. The electronic processor 300 sends to the database server 130 for storage, modifications made to product documentation and an indication of the determined organization. The electronic processor 200 stores the received modifications and stores the modifications in the database 212 along with an indication of the product documentation and organization associated with the modifications. In some embodiments, a user may only add content to product documentation or modify content that they previously added to the product documentation. In other embodiments, a user may also delete content included in the product documentation, modify content included in the product documentation, or both. In some embodiments, the electronic processor 300 also receives from the user device, an indication of a type of user. For example, a user editing product documentation may specify that a modification should be visible to one or more types of users. In these embodiments, the electronic processor 200 stores the received modifications in the database 212 with an indication of the type of user to whom the modification is visible along with an indication of the product documentation and organization associated with the modifications. In some embodiments, the electronic processor 300 receives, from a user device (for example, the user device 110), an indication of a user and a change to editing permissions associated with the user. For example, an administrator belonging to an organization may give a member of the organization the ability to edit the first product documentation 220.

In some embodiments, the database server 130 also stores, for each organization, metrics associated with product documentation distributed to the organization. The metrics may include, for example, how many times a section is viewed by users, how many times a term is searched by users, user reviews of product documentation, and the like. Upon receiving proper log-on credentials from a user device, the electronic processor 300 requests and receives, from the database server 130 metrics associated with an organization and the product documentation of one or more products that the organization has access to. The electronic processor 300 sends to the user device the metrics received from the database server 130. Based on the metrics an administrator of the organization may, for example, determine that members of the organization are in need of training, or product documentation is in need of modification.

FIG. 6 illustrates an example of a user interface, displayed by a display included in a user device that includes metrics for product documentation and options for modifying product documentation. In the example illustrated in FIG. 6, options for editing product documentation are displayed in a ribbon 600, options for navigating the document are displayed in a first pane 605, and metrics are displayed in a second pane 610. The second pane 610 may display a plurality of tabs that when selected cause the user device to display different metrics. For example, an overview tab 615, when selected, causes the user device to display viewing history of product documentation in the pane 610 and a comments tab 620, when selected, causes the user device to display comments made by users regarding product documentation.

It should be noted that, while described herein as being applied to software product documentation, the embodiments described herein may be applied to different types of documentation. For example, embodiments described herein may be applied to documentation for a physical product such as consumer products, commercial products, equipment, and the like.

Thus, embodiments described herein provide, among other things, a system and method for customizing product documentation without needing to duplicate the product documentation. Various features and advantages of some embodiments are set forth in the following claims.

What is claimed is:

1. A system for customizing product documentation, the system comprising:
an electronic computing device including an electronic processor, the electronic processor configured to:
receive, from a user device, log-on credentials;
determine, based on the log-on credentials, an organization;
receive, from a database server, product documentation for a product;
receive, from the database server, modifications for the product documentation that are associated with the organization;
apply the modifications to the product documentation to create modified product documentation; and
send, to the user device, the modified product documentation.

2. The system according to claim 1, wherein the electronic processor is further configured to receive, from the user device, a modification to the product documentation.

3. The system according to claim 2, wherein the modification is one selected from the group consisting of an addition to the product documentation and a modification of an addition previously made to the product documentation.

4. The system according to claim 1, wherein the electronic processor is configured to send, to the user device, metrics associated with the modified product documentation.

5. The system according to claim 4, wherein the metrics include an indication of how many times a section of the product documentation is viewed, user reviews of product documentation, or both.

6. The system according to claim 1, wherein the electronic processor is further configured to:
determine a version of the product documentation associated with the organization; and
receive, from a database server, product documentation for a product by sending a request to the database server for the determined version of the product documentation; and
receiving the determined version of the product documentation from the database server.

7. The system according to claim 1, wherein the electronic processor is further configured to:
determine, based on the log-on credentials a type of user; and
receive, from the database server, modifications for the product documentation that are associated with the organization by
sending, to the database server, a request for modifications for the product documentation that are associated with the organization and the type of user; and
receiving, from the database server, modifications for the product documentation that are associated with the organization and the type of user.

8. A method of customizing product documentation, the method comprising:
receiving, from a user device, log-on credentials;
determining, based on the log-on credentials, an organization;
receiving, from a database server, product documentation for a product;
receiving, from the database server, modifications for the product documentation that are associated with the organization;
applying the modifications to the product documentation to create modified product documentation; and
sending, to the user device, the modified product documentation.

9. The method according to claim 8, the method further comprising receiving, from the user device, a modification to the product documentation.

10. The method according to claim 9, wherein the modification is one selected from the group consisting of an addition to the product documentation and a modification of an addition previously made to the product documentation.

11. The method according to claim 8, the method further comprising sending, to the user device, metrics associated with the modified product documentation.

12. The method according to claim 11, wherein the metrics include an indication of how many times a section of the product documentation is viewed, user reviews of product documentation, or both.

13. The method according to claim 8, the method further comprising:
determining a version of the product documentation associated with the organization; and
wherein receiving, from a database server, product documentation for a product includes:
sending a request to the database server for the determined version of the product documentation; and
receiving the determined version of the product documentation from the database server.

14. The method according to claim 8, the method further comprising:
determining, based on the log-on credentials a type of user; and
wherein receiving, from the database server, modifications for the product documentation that are associated with the organization includes:
sending, to the database server, a request for modifications for the product documentation that are associated with the organization and the type of user; and
receiving, from the database server, modifications for the product documentation that are associated with the organization and the type of user.

15. Non-transitory computer-readable medium storing instructions that, when executed with an electronic processor, perform a set of functions, the set of functions comprising:
receiving, from a user device, log-on credentials;
determining, based on the log-on credentials, an organization;
receiving, from a database server, product documentation for a product;
receiving, from the database server, modifications for the product documentation that are associated with the organization;
applying the modifications to the product documentation to create modified product documentation; and
sending, to the user device, the modified product documentation.

16. The non-transitory computer-readable medium according to claim 15, the set of functions further comprising receiving, from the user device, a modification to the product documentation.

17. The non-transitory computer-readable medium according to claim 16, wherein the modification is one selected from the group consisting of an addition to the product documentation and a modification of an addition previously made to the product documentation.

18. The non-transitory computer-readable medium according to claim 15, the set of functions further comprising sending, to the user device, metrics associated with the modified product documentation.

19. The non-transitory computer-readable medium according to claim 15, the set of functions further comprising:
determining a version of the product documentation associated with the organization; and
wherein receiving, from a database server, product documentation for a product includes:
sending a request to the database server for the determined version of the product documentation; and
receiving the determined version of the product documentation from the database server.

20. The non-transitory computer-readable medium according to claim 15, the set of functions further comprising:
determining, based on the log-on credentials a type of user; and
wherein receiving, from the database server, modifications for the product documentation that are associated with the organization includes:
sending, to the database server, a request for modifications for the product documentation that are associated with the organization and the type of user; and
receiving, from the database server, modifications for the product documentation that are associated with the organization and the type of user.
